(19) United States
(12) Patent Application Publication
(10) Pub. No.: US 2019/0012782 A1
(43) Pub. Date: Jan. 10, 2019

(54) OPTICAL INSPECTION APPARATUS AND METHOD

(71) Applicant: Tyler Mark Thayer, Lake, MI (US)

(72) Inventor: Tyler Mark Thayer, Lake, MI (US)

(73) Assignee: Integrated Vision Systems LLC, Lake, MI (US)

(21) Appl. No.: 15/660,600

(22) Filed: Jul. 26, 2017

Related U.S. Application Data
(60) Provisional application No. 62/528,617, filed on Jul. 5, 2017.

(51) Int. Cl. G06T 7/00; G01B 11/00; G01N 21/88; G06T 7/60

(52) U.S. Cl. CPC G06T 7/0006; G06T 7/60; G01N 21/8851; G01B 11/00

(57) ABSTRACT

An optical inspection system includes a first optical sensor, a second optical sensor, and a drive system operatively connected to the first and second optical sensors and configured to selectively move the first optical sensor and second optical sensor with respect to one another. The ability to move the first and second optical sensors independently of one another facilitates the inspection of differently configured parts with a single inspection apparatus, thereby providing cost savings compared to purchasing or building multiple custom inspection fixtures.

### CROSS REFERENCE TO RELATED APPLICATION

This application claims the benefit of U.S. Provisional Patent Application No. 62/528,617, filed Jul. 5, 2017, and which is hereby incorporated by reference in its entirety.

### TECHNICAL FIELD

This disclosure relates to computerized optical inspection systems.

### BACKGROUND OF THE INVENTION

Optical inspection systems are employed to determine whether a workpiece, such as a manufactured object, is within design tolerance. An optical inspection system typically includes a camera or other light sensor.

### SUMMARY OF THE INVENTION

An optical inspection system includes a first optical sensor, a second optical sensor, and a drive system. The drive system supports the first and second optical sensors and is configured to selectively move the first optical sensor and second optical sensor with respect to each other. Accordingly, the drive system is capable of moving the first and second optical sensors independently of one another.

The ability to move the first and second optical sensors independently of one another facilitates the inspection of differently configured parts with a single inspection apparatus, thereby providing cost savings compared to purchasing or building multiple custom inspection fixtures.

A corresponding method is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, perspective view of an optical inspection system having a processor, a drive system, a platform, and first and second optical sensors;

FIG. 2 is a flow chart depicting the control logic of the processor of FIG. 1;

FIG. 3 is a schematic top view of the inspection system of FIG. 1 with a first component on the platform, the first optical sensor in a first position, and the second optical sensor in a second position;

FIG. 4 is a schematic top view of the optical inspection system of FIG. 1 with a second component on the platform, the first optical sensor in a third position, and the second optical sensor in a fourth position;

FIG. 5 is a flow chart depicting a method of using the optical inspection system of FIG. 1;

FIG. 6 is a schematic top view of the drive system of FIG. 1;

FIG. 7 is a schematic top view of the drive system of FIG. 6 in a different configuration;

FIG. 8 is a schematic depiction of a portion of an alternative optical inspection system having processing distributed between multiple processors;

FIG. 9 is a schematic, cross-sectional side view of an actuator and mechanism for use with the optical inspection system of FIG. 1 to selectively move the drive system and first and second optical sensors vertically; and

FIG. 10 is a schematic side view of one of the optical sensors of FIG. 1 with an actuator attached thereto to selectively rotate the optical sensor in an alternative embodiment.

### DESCRIPTION OF THE PREFERRED EMBODIMENTS

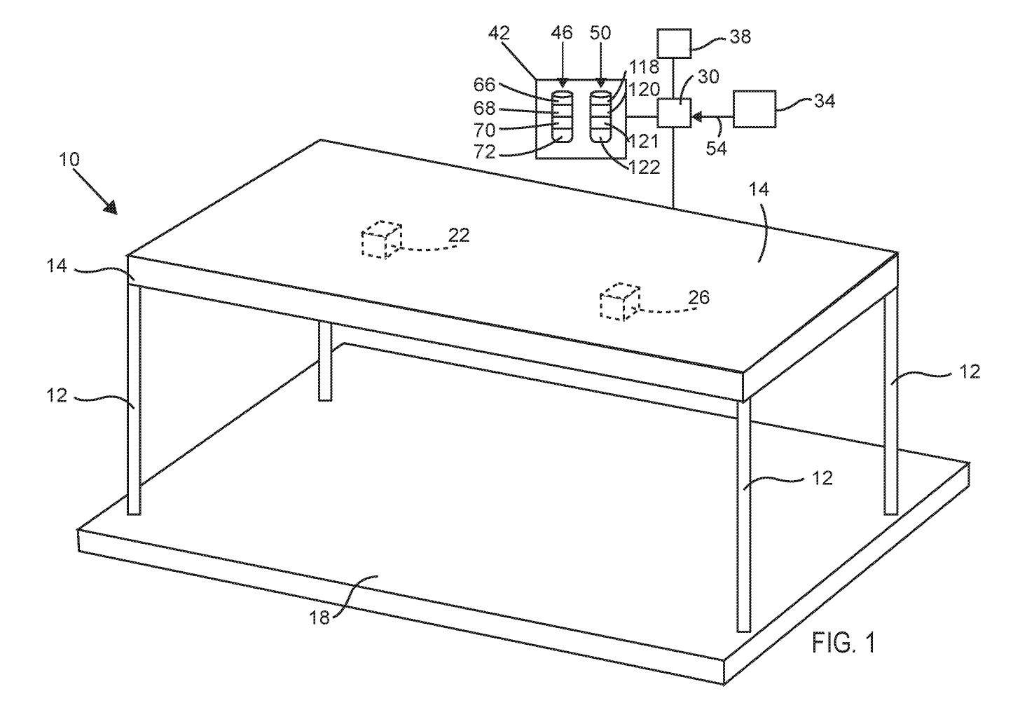

Referring to FIG. 1, an optical inspection system 10 is schematically depicted. The optical inspection system 10 includes a support structure 12 that supports a drive system 14 above an inspection platform 18. The system 10 further includes a first optical sensor 22 and a second optical sensor 26 operatively connected to the drive system 14 and suspended above the inspection platform 18. In one embodiment, the optical sensors 22, 26 are cameras.

More specifically, the drive system 14 is configured to selectively move the first and second optical sensors 22, 26 with respect to the platform 18 and with respect to each other. A processor 30 is operatively connected to, and configured to control, the drive system 14 and optical sensors 22, 26. The system 10 also includes an input device 34 through which a user of the system 10 may instruct the processor 30 or otherwise input information to the processor 30. An output device 38 is operatively connected to the processor 30 to receive signals from the processor 30 and generate a user-perceptible indicator in response thereto. The system 10 also includes a data storage medium 42 that is operatively connected to the processor 30 such that data stored on the medium 42 is selectively retrievable by the processor 30, i.e., the processor 30 can selectively obtain data stored on the medium 42.

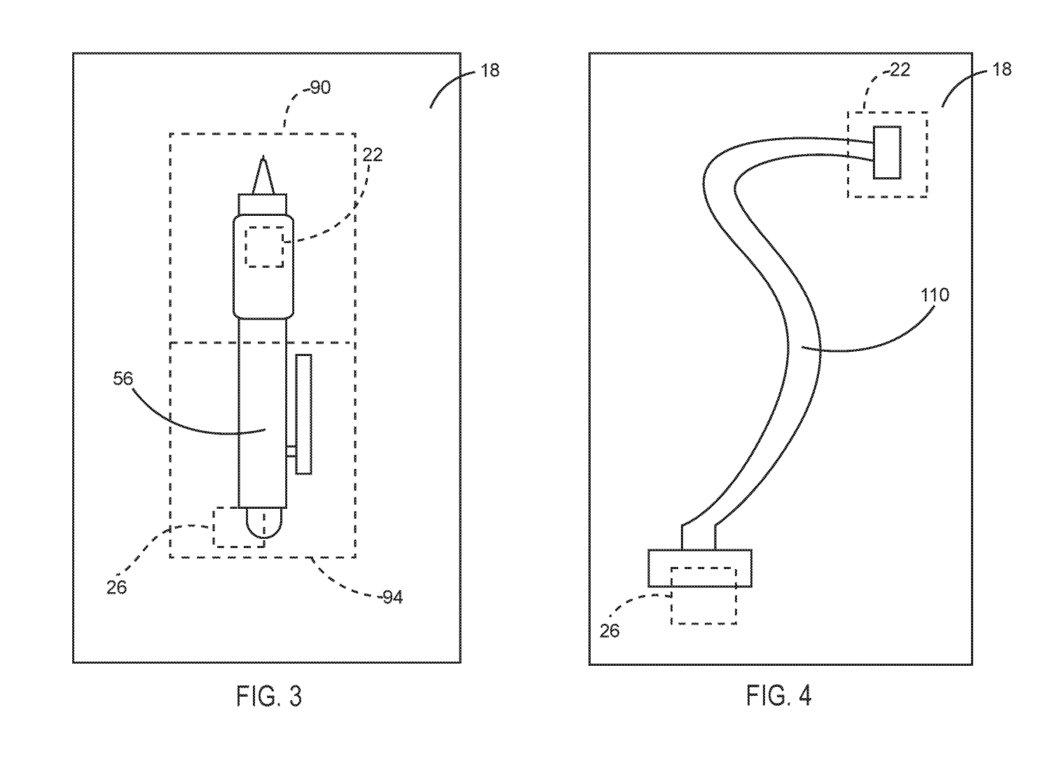

The optical inspection system 10 is configured to inspect a plurality of different components having different sizes and/or geometries. The data storage medium 42 stores data for a first component, i.e., stored first component data file 46. The data storage medium 42 also stores data for a second component, i.e., stored second component data file 50. One example of a first component is shown at 56 in FIG. 3; one example of a second component is shown at 110 in FIG. 4.

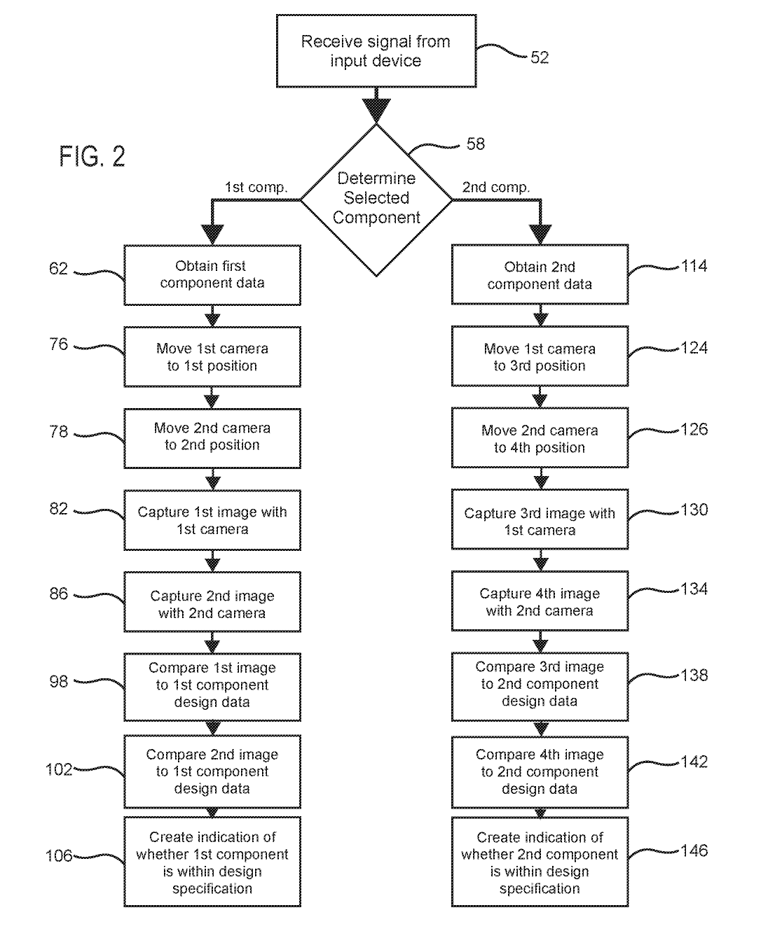

Referring to FIG. 2, a method of operation of the optical inspection system 10 is schematically depicted. The method of operation depicted in FIG. 2 represents an exemplary control logic used by the processor 30. In the embodiment depicted, the processor 30 is programmed and configured to carry out the steps shown and described in FIG. 2. Referring to FIG. 3, wherein like reference numbers refer to like components from FIG. 1, a first component 56 is disposed on the upper surface of the platform 18 for inspection. With reference to FIGS. 1-3, the method includes, at step 52, receiving a signal 54 from the input device 34 indicating which of a plurality of different components a user (not shown) desires to be inspected by the system 10. Those skilled in the art will recognize a variety of different input devices that may be employed, including, but not limited to, keyboards, computer mice, a touchscreen display, etc. In one embodiment, a screen may display the options available for the user to select. Signals may take any form within the scope of the claimed invention, including, but not limited to, electronic, wireless, etc. and may be digital or analog.

At step 58, the processor 30 determines which of the data files 46, 50 to retrieve or obtain from the storage medium 42 based on the signal 54 from the input device 34. More specifically, if the signal 54 indicates that the first component 56 is selected by the user, then the processor 30 proceeds to step 62. At step 62 the processor 30 obtains the stored first component data file 46 from the data storage medium 42. The stored first component data file 46 includes data describing a first position 66, data describing a second position 68, a first image file 70, and a second image file 72. The processor 30 then proceeds to step 76. At step 76, the processor 30 controls the drive system 14 to cause the movement of the first optical sensor 22 to the first position, as shown in FIG. 3. The processor 30 then proceeds to step 78, at which the processor 30 controls the drive system 14 to cause the movement of the second optical sensor 26 to the second position, as shown in FIG. 3.

The first and second positions are predetermined vantage points at which the optical sensors 22, 26 will capture images (“image data sets” or “sets of optical data”) of respective portions of the first component 56 within their respective fields of view. Following step 78, the processor 30 causes the first optical sensor 22 to obtain a first image data set at step 82; the processor 30 then causes the second optical sensor 26 to obtain a second image data set at step 86.

The first image file 70 includes data describing the design geometry of the portion 90 of the first component 56 to be sensed by the first optical sensor 22 in the first position. The second image file 72 includes data describing the design geometry of the portion 94 of the first component 56 to be sensed by the second optical sensor 26 in the second position. At step 98, the processor 30 compares the first image data set obtained at step 82 to the stored first image file 70 in a manner understood by those skilled in the art of optical inspection and thereby determines whether the portion 90 of the first component 56 captured by the first optical sensor 22 is within design specification. Similarly, at step 102, the processor 30 compares the second image data set obtained at step 86 to the stored second image file 72 in a manner understood by those skilled in the art of optical inspection and thereby determines whether the portion 94 of the first component 56 captured by the second optical sensor 26 is within design specification.

More specifically, the processor 30 determines whether the first image data set is within a predetermined amount of variance (i.e., within design tolerance) from the first data file. Similarly, the processor 30 determines whether the second image data set is within a predetermined amount of variance (i.e., within design tolerance) from the second data file.

At step 106, the processor 30 causes the output device 38 to generate an indicator, perceptible to a user of the system 10, that informs the user whether the first component 56 is within design specification, which the processor determined at steps 98 and 102. Those skilled in the art will recognize a variety of output devices that may be employed within the scope of the claimed invention, including, but not limited to, a visual display such as an LCD screen, lights, speakers, etc. The indicator may, for example, be an icon or color on a screen, a light, a sound, etc.

Returning to step 58, if the signal 54 indicates that the second component (shown at 110 in FIG. 4) is selected by the user, then the processor 30 proceeds to step 114. Referring to FIGS. 1, 2, and 4, at step 114, the processor 30 obtains the stored second component data file 50 from the data storage medium 42. The stored second component data file 50 includes data describing a third position 118, data describing a fourth position 120, a third image file 121, and a fourth image file 122. The processor 30 then proceeds to step 124. At step 124, the processor 30 controls the drive system 14 to cause the movement of the first optical sensor 22 to the third position relative to the platform 18, as shown in FIG. 4. The processor 30 then proceeds to step 126, at which the processor 30 controls the drive system 14 to cause the movement of the second optical sensor 26 to the fourth position relative to the platform 18, as shown in FIG. 4.

The third and fourth positions are predetermined vantage points at which the optical sensors 22, 26 will capture images of respective portions of the second component 110. Following step 126, the processor 30 causes the first optical sensor 22 to obtain a third image data set at step 130; the processor 30 then causes the second optical sensor 26 to obtain a fourth image data set at step 134.

The third image file 121 includes data describing the design geometry of the portion of the second component 110 to be sensed by the first optical sensor 22 in the third position. The fourth image file 122 includes data describing the design geometry of the portion of the second component 110 to be sensed by the second optical sensor 26 in the fourth position. At step 138, the processor 30 compares the third image data set obtained at step 130 to the stored third image file 121 in a manner understood by those skilled in the art of optical inspection and thereby determines whether the portion of the second component 110 captured by the first optical sensor 22 at step 130 is within design specification. Similarly, at step 142, the processor 30 compares the fourth image data set obtained at step 134 to the stored fourth image file 122 in a manner understood by those skilled in the art of optical inspection and thereby determines whether the portion of the second component 110 captured by the second optical sensor 26 at step 134 is within design specification.

More specifically, the processor 30 determines whether the third image data set is within a predetermined amount of variance (i.e., within design tolerance) from the third data file. Similarly, the processor 30 determines whether the fourth image data set is within a predetermined amount of variance (i.e., within design tolerance) from the fourth data file.

Following steps 138 and 143, the processor 30 causes the output device 38 to generate an indicator, perceptible to a user of the system 10, that informs the user whether the second component 110 is within design specification at step 146.

Thus, the system 10 enables a single device to effectively inspect at least two components, e.g., first component 56 and second component 110, having different shapes, sizes, and design specifications, thereby reducing costs compared to procuring a separate custom inspection apparatus for each component configuration. Further, the system 10 reduces the time required to inspect a complex part compared to an inspection apparatus having only a single optical sensor.

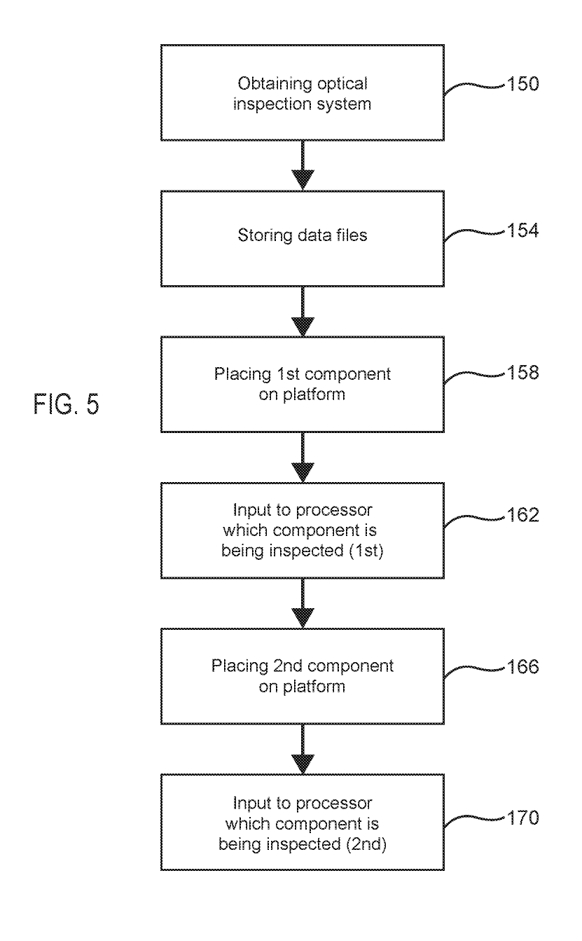

FIG. 5 depicts a method of using the system 10. Referring to FIGS. 1 and 5, the method includes obtaining the system 10 at step 150. The method also includes storing a plurality of data files 46, 50 on the data storage medium 42 at step 154. The method also includes placing a first component (as shown at 56 in FIG. 3) on the platform 18 at step 158, and instructing the processor 30 (via input device 34) to retrieve and use data file 46 from the storage medium 42 at step 162. The method also includes removing the first component from the platform 18 and placing the second component (as shown at 110 in FIG. 4) on the platform 18 at step 166, and instructing the processor 30 (via input device 34) to retrieve and use data file 48 from the storage medium 42 at step 170.

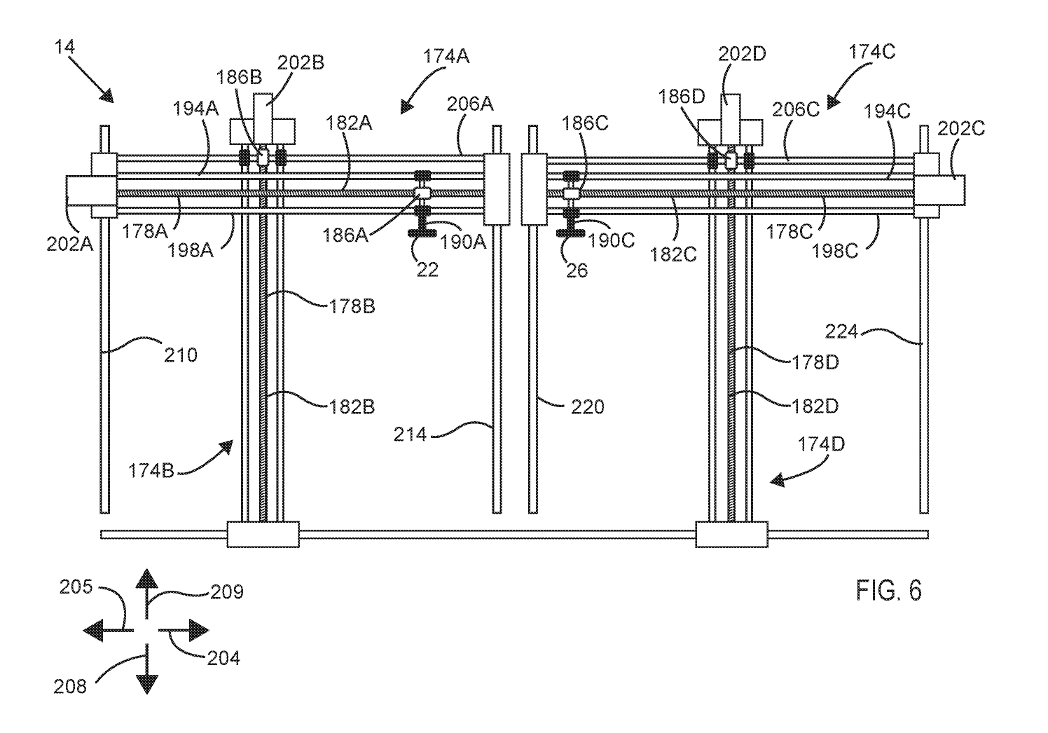

The drive system 14 may have any configuration that permits independent movement of the optical sensors 22, 26 relative to one another within the scope of the claims. For example, the drive mechanism 14 may employ a rack and pinion system, belts and pulleys, etc. The drive system 14 in the embodiment depicted employs screw drive mechanisms. More specifically, and with reference to FIG. 6, wherein like reference numbers refer to like components from FIGS. 1-5, the drive system 14 includes lead screw linear drive mechanisms 174A, 174B, 174C, 174D. Drive mechanism 174A includes a lead screw 178A characterized by external helical threads 182A, as understood by those skilled in the art.

Drive mechanism 174A further includes a drive nut 186A having internal helical threads. The lead screw 178A extends through the hole of drive nut 186A such that the threads 182A of the lead screw 178A are engaged with the threads of the drive nut 186A. As understood by those skilled in the art, rotation of the lead screw 178A about its centerline causes the drive nut 186A to move linearly along the centerline of lead screw 178A. Optical sensor 22 is mounted to the drive nut 186A via a bracket 190A. Accordingly, rotation of lead screw 178A causes linear translation of the optical sensor 22.

Drive mechanism 174A also includes two cylindrical guide rods 194A, 198A, that are parallel to each other and to the lead screw 178A. The bracket 190A defines two holes; each of the rods 194A, 194B extends through a respective one of the holes. The rods 194A, 198A thereby interact with the bracket 190A to substantially limit movement of the bracket 190A and the optical sensor 22 to linear translation. Drive mechanism 174A further includes an actuator 202A that is operatively connected to the lead screw 178A and configured to selectively apply torque to the lead screw 178A and thereby cause the lead screw 178A to rotate about its centerline. In the embodiment depicted, actuator 202A is a stepper motor.

Thus, drive mechanism 174A is configured to selectively cause movement of the first optical sensor 22 in one of two opposite directions 204, 205 along the axis of rotation of the lead screw 178A. Drive mechanism 174B is configured to selectively cause movement of the first optical sensor 22 in either of two opposite directions 208, 209 perpendicular to the axis of rotation of the lead screw 178A and directions 204, 205.

More specifically, drive mechanism 174B includes a lead screw 178B characterized by external helical threads 182B, as understood by those skilled in the art. Lead screw 178B is oriented perpendicularly to lead screw 178A. Drive mechanism 174B further includes a drive nut 186B having internal helical threads. The lead screw 178B extends through the hole of drive nut 186B such that the threads 182B of the lead screw are engaged with the threads of the drive nut 186B. As understood by those skilled in the art, rotation of the lead screw 178B about its centerline causes the drive nut 186B to move linearly along the centerline of lead screw 178B.

The drive nut 186B is mounted to drive mechanism 174A. For example, drive mechanism 174A may include a structural member 206 to which the drive nut 186B is mounted. Accordingly, rotation of lead screw 178B causes linear movement of the drive mechanism 174A and, correspondingly, the first optical sensor 22, in two opposite directions 208, 209 that are perpendicular to directions 204, 205. Drive mechanism 174A engages two cylindrical guide rods 210, 214 that are parallel to each other and to the lead screw 178B. The guide rods 210, 214 are supported by the support structure 12 and retain the drive mechanism 174A above the platform 18. The guide rods 210, 214 also restrict movement of the drive mechanism 174A to directions 208, 209. Drive mechanism 174B further includes an actuator 202B that is operatively connected to the lead screw 178B and configured to selectively apply torque to the lead screw 178B and thereby cause the lead screw 178B to rotate about its centerline. In the embodiment depicted, actuator 202B is a stepper motor.

Drive mechanism 174C includes a lead screw 178C characterized by external helical threads 182C, as understood by those skilled in the art. Drive mechanism 174C further includes a drive nut 186C having internal helical threads. The lead screw 178C extends through the hole of drive nut 186C such that the threads 182C of the lead screw 178C are engaged with the threads of the drive nut 186C. As understood by those skilled in the art, rotation of the lead screw 178C about its centerline causes the drive nut 186C to move linearly along the centerline of lead screw 178C. Optical sensor 26 is mounted to the drive nut 186C via a bracket 190C. Accordingly, rotation of lead screw 178C causes linear translation of the optical sensor 26.

Drive mechanism 174C also includes two cylindrical guide rods 194C, 198C, that are parallel to each other and to the lead screw 178C. The bracket 190C defines two holes; each of the rods 194C, 194C extends through a respective one of the holes. The rods 194C, 198C thereby interact with the bracket 190C to substantially limit movement of the bracket 190C and the optical sensor 26 to linear translation. Drive mechanism 174C further includes an actuator 202C that is operatively connected to the lead screw 178C and configured to selectively apply torque to the lead screw 178C and thereby cause the lead screw 178C to rotate about its centerline. In the embodiment depicted, actuator 202C is a stepper motor.

Thus, drive mechanism 174C is configured to selectively cause movement of the second optical sensor 26 in either of two opposite directions 204, 205 along the axis of rotation of the lead screw 178C. Drive mechanism 174D is configured to selectively cause movement of the second optical sensor 26 in either of two opposite directions 208, 209 perpendicular to the axis of rotation of the lead screw 178C and directions 204, 205.

More specifically, drive mechanism 174D includes a lead screw 178D characterized by external helical threads 182D, as understood by those skilled in the art. Lead screw 178D is oriented perpendicularly to lead screw 178C. Drive mechanism 174D further includes a drive nut 186D having internal helical threads. The lead screw 178D extends through the hole of drive nut 186D such that the threads 182D of the lead screw are engaged with the threads of the drive nut 186D. As understood by those skilled in the art, rotation of the lead screw 178D about its centerline causes the drive nut 186D to move linearly along the centerline of lead screw 178D.

The drive nut 186D is mounted to drive mechanism 174C. For example, drive mechanism 174C may include a structural member 206 to which the drive nut 186D is mounted. Accordingly, rotation of lead screw 178D causes linear movement of the drive mechanism 174C and, correspondingly, the second optical sensor 26, in two opposite directions 208, 209 that are perpendicular to directions 204, 205. Drive mechanism 174C engages two cylindrical guide rods 220, 224 that are parallel to each other and to the lead screw 178C. The guide rods 220, 224 are supported by the support structure 12 and retain the drive mechanism 174C above the platform 18. The guide rods 220, 224 also restrict movement of the drive mechanism 174C to directions 208, 209. Drive mechanism 174D further includes an actuator 202D that is operatively connected to the lead screw 178D and configured to selectively apply torque to the lead screw 178D and thereby cause the lead screw 178D to rotate about its centerline. In the embodiment depicted, actuator 202D is a stepper motor.

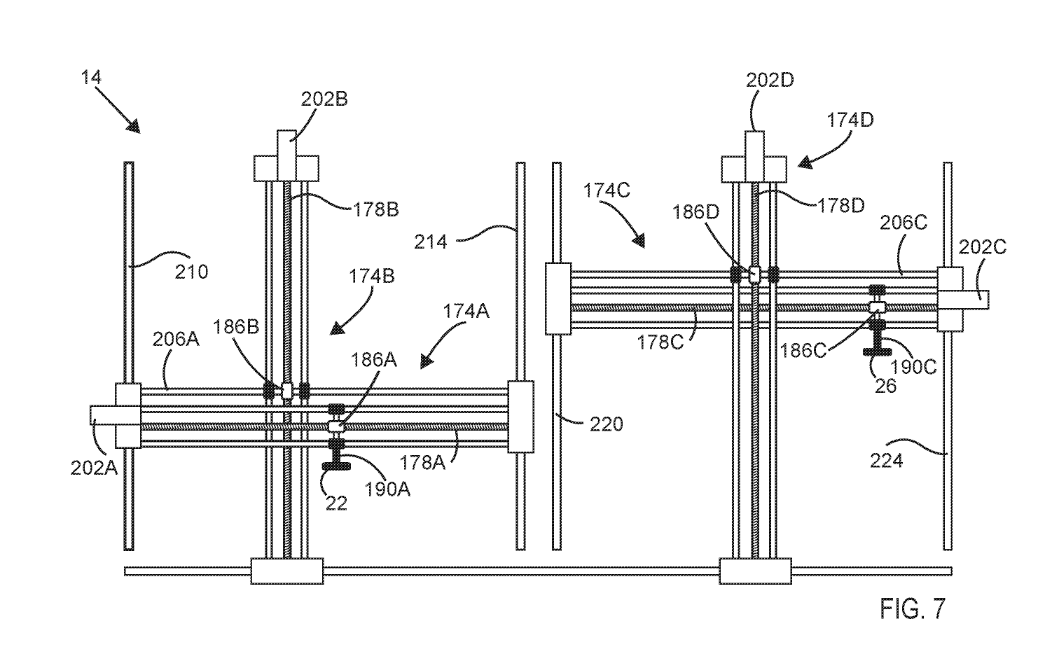

The processor 30 is operatively connected to, and configured to control, the actuators 202A, 202B, 202C, 202D. Accordingly, the processor 30 selectively causes the movement of the first optical sensor 22 through application of torque by the actuators 202A, 202B. Similarly, the processor 30 selectively causes the movement of the second optical sensor 26 through application of torque by the actuators 202C, 202D. Referring to FIG. 7, wherein like reference numbers refer to like components from FIGS. 1-6, exemplary movement of drive mechanisms 174A, 174C and optical sensors 22, 26 is depicted.

Accordingly, the drive system 14 depicted is configured such that each of the optical sensors 22, 26 is movable to any point within a portion of a plane. Movement of the first optical sensor 22 in directions 204, 205 is achieved by the application of torque to lead screw 178A by actuator 202A; movement of the first optical sensor 22 in directions 208, 209 is achieved by the application of torque to lead screw 178B by actuator 202B. Movement of the second optical sensor 26 in directions 204, 205 is achieved by the application of torque to lead screw 178C by actuator 202C; movement of the second optical sensor 26 in directions 208, 209 is achieved by the application of torque to lead screw 178D by actuator 202D.

As used herein, the first, second, third, and fourth positions are relative to a fixed, stationary portion of the inspection system 10, such as the platform 18 or support structure 12. The first, second, third, and fourth positions may, for example, be expressed as points on a Cartesian plane, though other ways of expressing the positions may be employed within the scope of the claimed invention.

It should be noted that, in the context of the claimed invention, a “processor” may include a plurality of processors that cooperate to perform the operations described herein. Those skilled in the art will recognize a variety of data storage media that may be employed within the scope of the claimed invention. For example, data storage medium 194 may be a hard drive, read-only memory, writable read-only memory, optical media such as a compact disk, etc. It should also be noted that, in the context of the claimed invention, a “data storage medium” may include multiple storage media that together store the data used by the processor. Similarly, an “output device” may include one or more output devices.

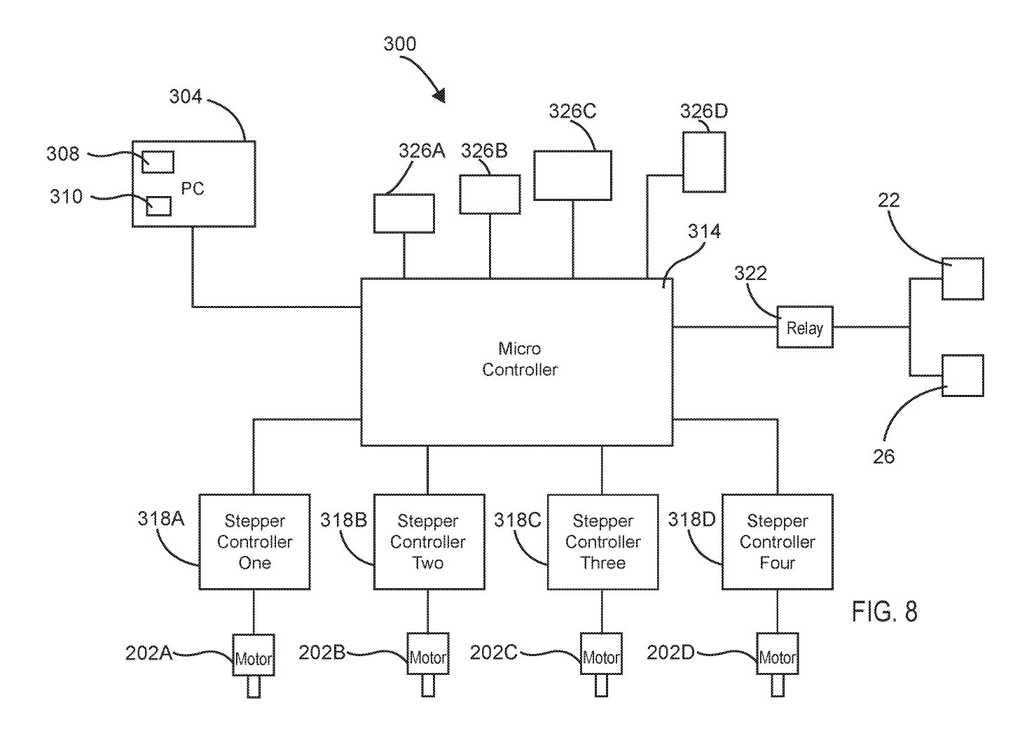

FIG. 8 schematically depicts an alternative embodiment within the scope of the claims that includes a plurality of processors that cooperate to perform the steps shown in FIG. 2. Referring to FIG. 8, wherein like reference numbers refer to like components from FIGS. 1-7, optical inspection system 300 includes a personal computer 304, i.e., one processor, that includes an input device 308 that performs the same functions as the input device shown at 34 in FIG. 1. Personal computer 304 also includes a data storage medium 310 that performs the same functions as the data storage medium shown at 42 in FIG. 1. Referring to FIGS. 2 and 8, the personal computer 304 perfoms steps 52 and 58. When a user selects which data file to use via the input device 308, the personal computer 304 performs either step 62 or step 114 of FIG. 2, depending on which component is selected. The personal computer 304 then transmits the data obtained at step 62 or 114 to a microcontroller 314, i.e., another processor.

Each actuator 202A, 202B, 202C, 202D is directly controlled by a respective stepper controller 318A, 318B, 318C, 318D. The microcontroller 314 transmits position data to each stepper controller 318A, 318B, 318C, 318D to effectuate movement of the optical sensors 22, 26 to their desired positions. Thus, microcontroller 314 cooperates with stepper controllers 318A, 318B, 318C, 318D to perform steps 76, 78, 124, and 126. The drive mechanisms interconnecting the optical sensors 22, 26 and the actuators 202A, 202B, 202C, 202D are not shown in FIG. 8 for clarity but are substantially similar to the ones shown in FIGS. 6 and 7.

In the embodiment depicted in FIG. 8, optical sensors 22, 26 are stand-alone units each having a respective processor (not shown) that performs steps 82-106 and steps 130-146. Microcontroller 314 is configured to transmit the design data (i.e., image files 68, 70, 120, 122) received by the personal computer 304 to the processors of the optical sensors 22, 26 via relay 322.

If the first component is selected at step 58, then the processor of optical sensor 22 performs steps 82, 98, and 106 (for the portion of the first component inspected by the first optical sensor 22), and the processor of optical sensor 26 performs steps 86, 102, and 106 (for the portion of the first component inspected by the second optical sensor 26). Similarly, if the second component is selected at step 58, then the processor of optical sensor 22 performs steps 130, 138, and 146 (for the portion of the second component inspected by the first optical sensor 22), and the processor of optical sensor 26 performs steps 134, 142, and 146 (for the portion of the second component inspected by the second optical sensor 26). Optical sensors 22, 26 may have respective output devices (not shown) to indicate whether components are within design specification.

A plurality of limit switches 326A-D or other feedback devices is operatively connected to the microcontroller 314 to provide feedback to the microcontroller 314 regarding the movement and position of the optical sensors 22, 26, as understood by those skilled in the art.

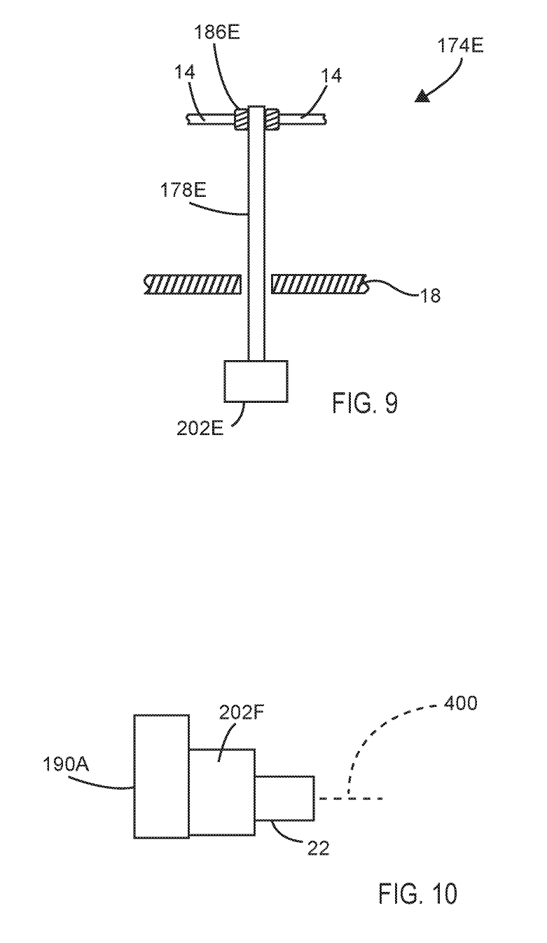

Although the inspection systems 10, 200 are depicted with four actuators for movement of the optical sensors 22, 26 within a horizontal plane, the drive system 14 may be configured for additional actuators to cause vertical movement of the optical sensors 22, 26. Referring to FIG. 9, wherein like reference numbers refer to like components from FIGS. 1-8, a screw drive mechanism 174E is configured to selectively move the drive system 14, and correspondingly the optical sensors 22, 26, vertically. Drive mechanism 174E includes a lead screw 178E that is vertically oriented, and that is engaged with a drive nut 186E. Drive nut 186E is mounted to the drive system 14. Accordingly, rotation of the lead screw 178E about a vertical axis causes vertical movement of the optical sensors 22, 26. Actuator 202E is configured to selectively rotate lead screw 178E, and is controlled by processor 30. Referring to FIG. 10, an actuator 202F operatively interconnects optical sensor 22 to bracket 190A; actuator 202F is configured to selectively rotate optical sensor 22 about a horizontal axis 400.

It should be noted that fixtures (not shown) may be employed to positively position the components 56, 110 on the platform 18. Pins on the fixture may be inserted into holes (not shown) in platform 18 to assist a user with properly positioning the component for inspection.

While the best modes for carrying out the invention have been described in detail, those familiar with the art to which this invention relates will recognize various alternative designs and embodiments for practicing the invention within the scope of the appended claims.

1. An optical inspection system comprising:
a first optical sensor;
a second optical sensor; and
a drive system operatively connected to the first and second optical sensors and configured to selectively move the first optical sensor and second optical sensor with respect to one another.

2. The optical inspection system of claim 1, further comprising a processor operatively connected to the drive system such that the movement of the first and second optical sensors is controllable by the processor.

3. The optical inspection system of claim 2, further comprising a data storage medium on which data describing a first position, a second position, a third position, and a fourth position is storable;
said processor being operatively connected to the data storage medium and configured to obtain the data describing the first position, the second position, the third position, and the fourth position.

4. The optical inspection system of claim 3, further comprising an input device operatively connected to the processor and configured to transmit a signal to the processor that is indicative of whether a user has selected to inspect a first component or a second component having different design geometry from the first component;
wherein the processor is configured to cause the first optical sensor to move to the first position and the second optical sensor to move to the second position in response to the signal being indicative of the user selecting to inspect the first component; and
wherein the processor is configured to cause the first optical sensor to move to the third position and the second optical sensor to move to the fourth position in response to the signal being indicative of the user selecting to inspect the second component.

5. The optical inspection system of claim 4,
wherein the data storage medium is configured such that a first data file, a second data file, a third data file, and a fourth data file are storable on the data storage medium for retrieval by the processor;
wherein the processor is configured to obtain the first and second data files in response to the signal being indicative of the user selecting to inspect the first component; and
wherein the processor is configured to obtain the third and fourth data files in response to the signal being indicative of the user selecting to inspect the second component.

6. The optical inspection system of claim 5, wherein the first optical sensor is configured to selectively generate a first set of optical data and the second optical sensor is configured to selectively generate a second set of optical data;
wherein the processor is configured such that, in response to the signal being indicative of the user selecting to inspect the first component, the processor
causes the first optical sensor to generate the first set of optical data in the first position,
causes the second optical sensor to generate the second set of optical data in the second position,
determines whether the first set of optical data is within a predetermined amount of variance from the first data file,
determines whether the second set of optical data is within a predetermined amount of variance from the second data file, and
causes an output device to produce a perceptible indication if the first set of optical data is not within the predetermined amount of variance of the first data file or the second set of optical data is not within the predetermined amount of variance of the second data file.

7. The optical inspection system of claim 6, wherein the processor is configured such that, in response to the signal being indicative of the user selecting to inspect the second component, the processor
causes the first optical sensor to generate the first set of optical data in the third position,
causes the second optical sensor to generate the second set of optical data in the fourth position,
determines whether the first set of optical data is within a predetermined amount of variance from the third data file,
determines whether the second set of optical data is within a predetermined amount of variance from the fourth data file, and
causes an output device to produce a perceptible indication if the first set of optical data is not within the predetermined amount of variance of the third data file or the second set of optical data is not within the predetermined amount of variance of the fourth data file.

8. A method comprising:
possessing an optical inspection system including
a first optical sensor,
a second optical sensor,
a drive system supporting the first and second optical sensors and configured to selectively move the first optical sensor and second optical sensor with respect to one another,
a data storage medium,
a processor operative connected to the data storage medium and configured to selectively retrieve data from the optical storage medium, operatively connected to the drive system and configured to control the movement of the first and second optical sensors, and
an input device configured to transmit a signal to the processor that is indicative of whether a user has selected to inspect a first component or a second component having different design geometry from the first component;
storing on the data storage medium a first position, a second position, a third position, and a fourth position, a first data file, a second data file, a third data file, and a fourth data file;
said first data file including design geometry of a first portion of a first component, said second data file including design geometry of a second portion of the first component, said third data file including design geometry of a first portion of second component, and said fourth data file including design geometry of a second portion of the second component;
positioning the first component relative to the optical sensor system for inspection;
causing the drive system to move the first optical sensor to the first position;
causing the drive system to move the second optical sensor to the second position;
causing the first optical sensor to obtain a first image data set of the first portion of the first component; and
causing the second optical sensor to obtain a second image data set of the second portion of the first component.

9. The method of claim 4, further comprising:
positioning the second component relative to the optical sensor system for inspection;
causing the drive system to move the first optical sensor to the third position;
causing the drive system to move the second optical sensor to the fourth position;
causing the first optical sensor to obtain a third image data set of the first portion of the second component; and
causing the second optical sensor to obtain a fourth image data set of the second portion of the second component.

10. The method of claim 9, further comprising comparing the first image data set to the first data file and thereby determining whether the first portion of the first component is within a predetermined amount of variance of the design geometry of the first portion of the first component;
comparing the second image data set to the second data file and thereby determining whether the second portion of the first component is within a predetermined amount of variance of the design geometry of the second portion of the first component;
comparing the third image data set to the third data file and thereby determining whether the first portion of the second component is within a predetermined amount of variance of the design geometry of the first portion of the second component; and
comparing the fourth image data set to the fourth data file and thereby determining whether the second portion of the second component is within a predetermined amount of variance of the design geometry of the second portion of the second component.

11. The method of claim 10, further comprising causing an output device to generate a perceptible indication of whether any of said portions are not within their respective design geometries.
